(19) United States
(12) Patent Application Publication
(10) Pub. No.: US 2010/0115691 A1
(43) Pub. Date: May 13, 2010

(54) BASIN, ELEMENTS AND METHOD FOR MANUFACTURING SUCH A BASIN

(76) Inventor: Johannes Gommert Van Der Klooster, Hertogenbosch (NL)

Correspondence Address: LAW OFFICES OF ERIC KARICH, 2807 ST. MARK DR., MANSFIELD, TX, 76063, US

(21) Appl. No.: 12/523,728

(22) PCT Filed: Jan. 17, 2007
(86) PCT No.: PCT/NL08/50036

§ 371 Date: Jan. 13, 2010

(30) Foreign Application Priority Data
Jan. 19, 2007 (NL) 2000445
May 4, 2007 (NL) 2000628

(51) Int. Cl. E04H 4/00; B23P 17/04

(52) U.S. Cl. 4/506; 29/428

(57) ABSTRACT

A method for constructing a concrete basin includes the steps of manufacturing concrete construction elements, transporting the construction elements to the construction site for the basin, joining the construction elements together to form a basin, and arranging covering on the inner side of the walls and bottom of the basin. The inner covering is arranged during the manufacture of the construction elements. The invention also relates to a basin manufactured with such a method and the elements to be used in the construction of such a basin. The basin can be a swimming pool basin or a pond basin. By first covering the construction elements on their inner side and then transporting them to the site and installing them the construction process can be better managed and the working time on site is shortened.

The market for private swimming pools traditionally distinguishes two types of swimming pool basin, i.e. swimming pool basins constructed on site in the classic manner from concrete, and lighter swimming pools which are usually manufactured from plastic and the parts of which are prefabricated, subsequently transported to the construction site and assembled at the construction site. The appearance and the durability of this type of swimming pool is generally of considerably lesser quality than that of swimming pools constructed in accordance with the classic construction method. Swimming pools constructed on site in the classic manner are considerably more expensive than the so-called prefab swimming pools, and require a longer construction time.

There is a need in the market for swimming pools which combine the shorter construction time for swimming pools of the second type with the attractive appearance and the greater durability of swimming pools of the first type. A swimming pool basin is thus known from DE-U-79 30433 comprising at least one monolithic U-shaped construction element which is manufactured substantially from concrete and which comprises two side wall parts and two end construction elements manufactured substantially from concrete, wherein the side wall parts of the U-shaped construction elements are placed with their end surface against each other and wherein the end construction elements are placed with their end surface against the end surface of the outer U-shaped construction elements. This document thus describes a swimming pool, the component construction elements of which are prefabricated, transported to the construction site and assembled and installed at the construction site. The appearance and the durability of a swimming pool basin manufactured in classic manner is hereby obtained at a considerably lower price and a considerably shorter construction time.

This document moreover describes a method for constructing a concrete basin, comprising the following steps of: manufacturing concrete construction elements, transporting the construction elements to the construction site for the swimming pool, joining the construction elements together to form a basin shell and arranging covering on the inner side of the walls and bottom of the basin shell.

In this prior art method the basin shell is initially installed on-site, and the covering is then arranged on the inner side. This requires much manual labour and drying time, which thus entails an increase in the on-site construction time and a process which is more difficult to control.

The invention has for its object to provide such a method wherein these problems are obviated.

This object is achieved with such a method wherein the inner covering is arranged before the construction elements are transported to the construction site for the basin. The arranging of an inner covering is also understood to mean for instance the polishing or grinding of the concrete provided with for instance crushed stone; these are after all processes which can be performed more easily in controlled manner in an industrial environment.

The construction elements fully covered on their inner side are then transported to the site and installed. This results in a better manageability of the process, and a shorter working time on site.

This object is likewise achieved with a basin comprising at least one U-shaped construction element which is manufactured substantially from concrete and which comprises a floor part and at least two side wall parts and two end construction elements manufactured substantially from concrete, wherein the side wall parts of the U-shaped elements are placed with their end surface against each other and wherein the end construction elements are placed with their end surface against the end surface of the outermost U-shaped construction elements, wherein the construction elements are mutually separated by sealing elements, and wherein a gutter-like structure forming a monolithic whole with the U-shaped construction element is arranged connecting to the upper edge of both side wall parts of the U-shaped construction elements.

Reference is further made to FR-A-2 375 410. This document shows a swimming pool basin, the walls of which are formed by separate prefabricated plastic elements, while the bottom is formed by concrete poured on site and wherein parts of the panels forming the side walls are cast in.

It is pointed out here that the measures according to the invention are particularly applicable to swimming pool basins. They can however also be successfully applied to other forms of basin, such as ponds or manure basins. Swimming pool basins are also understood to mean swimming pool basins for horses. The measures according to the invention can also be successfully applied to for instance caissons as basis for floating buildings, clamp silos, manure pits, or for cellars.

This embodiment also provides a U-shaped construction element provided on its inner side with a covering. The construction element is transported in this form from the workplace to the construction site.

This method is further simplified, particularly by improving the handling of all types of elements, if the basin is assembled from at least one U-shaped construction element and two end construction elements.

Particularly the transport of the construction elements is made easier if the U-shaped construction elements are only assembled at the construction site. This is because only construction elements extending substantially in one plane, i.e. the floor part and the side wall parts, hereby need be transported. These elements extending in one plane are then assembled at the construction site to form a U-shaped construction element which is subsequently added to the already completed part of the basin. While this does result in seal junctions, this is less of a problem than it used to be owing to the materials and seals which have recently become available. It is pointed out here that the phrase ‘elements extending in one plane’ is understood to mean elements which describe a flat or curved main plane and the dimension of which in the direction transversely of the main plane, or the thickness, is at least a factor of three smaller than the smallest dimension of the main plane.

This preferred embodiment likewise provides the measure that end construction elements extending substantially vertically and manufactured substantially from concrete are arranged on the outer side of the U-shaped construction elements.

According to the prior art the construction elements are mutually connected by tension rods extending over all elements together. These can however only be arranged once all construction elements have been placed, which makes the arranging of these tension rods difficult because of the poor accessibility. The assembly of the basin is simplified if, aAer placing of a construction element connecting to a construction element that is already present, the placed construction element is connected to the already present construction element before a subsequent construction element is placed.

This embodiment also provides the measure that the construction elements are mutually connected by self-locking dowels. It is hereby possible to mutually connect parts of a basin by pressing them against each other in a manner per se known from tunnel construction. Swimming pools have recently been developed with an overflow edge. Because the edges of the basin are no longer visible, a more attractive appearance is hereby obtained. There is therefore a need in the quality swimming pool market segment for swimming pools of the type stated in the preamble provided with overflow gutters. It is in principle possible to add such overflow gutters during installing of the basin, although this results in additional operations for the purpose of arranging the overflow gutters and sealing problems moreover occur. In order to obviate these problems a preferred embodiment provides such a basin wherein a gutter-like structure is arranged connecting to the upper edge of both side wall parts of the U-shaped elements and forming a monolithic whole with the associated side wall part.

The invention also relates to a U-shaped element as component for a basin, comprising a floor part and two side wall parts, wherein the U-shaped element is manufactured from concrete, wherein a gutter-like structure is arranged connecting to the upper edge of both side wall parts of the U-shaped construction element and forming a monolithic whole with the U-shaped construction element. It is noted here that this U-shaped construction element can be assembled from a bottom part and side wall parts, i.e. elements which extend in one plane. As a result of these measures an assembly of basin and gutter is obtained which can be installed in a single operation and wherein the sealing problems are limited to a minimum.

Although it is possible in principle, and attractive in respect of the handling of the construction elements during transport and installation, to arrange the gutter on the inner side of the wall of the basin, according to a preferred embodiment the gutter-like structures are arranged on the outer side of the side wall parts of the U-shaped construction elements. This prevents the side wall of the basin under the overflow gutter lying further outward.

A terrace is in many cases built connecting to the basin. This results in an exceptionally attractive appearance, particularly in the case of basins with an overflow edge. In order to facilitate the connection between terrace and basin and in order to improve the appearance, a preferred embodiment provides the measure that the U-shaped elements are provided with support noses arranged against the outer wall of the gutter-like structures and forming a monolithic whole with the U-shaped construction element.

In order to increase the structural strength of the basin a preferred embodiment provides the measure that the U-shaped construction elements are provided with supports arranged under the gutter-like structures against the outer sides of the side walls and forming a monolithic whole with the U-shaped construction element.

Basins, in particular a swimming pool basin, require a number of conduits, such as for feed and discharge of basin water and for supplying nozzles, in addition to electrical lines for lighting and installations. In order to facilitate arrangement hereof, a further preferred embodiment provides the measure that openings for passage of at least one conduit are arranged in the supports. Due to the large space available for this conduit it is placed clear of the ground so that a possible settlement of the ground does not result in bending or breaking of pipes or conduits.

A particularly attractive embodiment provides the measure that the construction element is provided with at least one conduit formed integrally with the construction element. It will be apparent that this embodiment sets high standards for the seals between the construction elements, since these seals also form the seals of the conduits.

It is however also possible for the construction element to be provided with at least one conduit arranged in a cavity bounded by two substantially flat parts. The conduit is hereby enclosed between two parts, for instance between a floor part and a side wall part. The conduit can herein be formed by a separate conduit enclosed in the relevant space, this providing the option that the conduit is formed integrally together with nozzles leading to the interior of the basin and is placed as such. It is however also possible for the walls of the conduits to be formed by parts of the relevant elements, which entails the conduit being provided with seals extending in the length direction of the conduits. The nozzles can here also be co-moulded. It will be apparent that such cast or enclosed conduits can be accommodated in U-shaped elements assembled from separate parts, but that integrally formed U-shaped elements can also be provided with cast conduits. In order to save weight and to improve the resistance to rust, the U-shaped construction elements are reinforced by plastic or metal fibres.

Yet another embodiment provides the measure that the basin is manufactured from high-strength concrete. High-strength concrete is understood to mean concrete with a compression strength greater than 65 MPa. The wall thickness can hereby be considerably limited, this also resulting in a lower mass of the components of the basin so that transport is facilitated. High-strength concrete has the further advantage of a lower permeability to water and a greater durability than the usual types of concrete. Use can also be made of types of concrete such as self-compacting concrete, which flow better during pouring so that the formation of air bubbles is avoided, and the distance between the reinforcement and the side surfaces can be reduced, whereby the wall thickness of the elements can be decreased still further. It will be apparent that this measure entails that not only the U-shaped elements but all other concrete elements can be manufactured from such types of concrete.

The gutter will in many cases also extend along the end walls of the basin. In order to also obtain the advantages of the invention in this embodiment, the end construction elements are both provided with a concrete gutter-like element which forms a monolithic whole with the end wall and which connects to the gutter-like elements of the adjacent U-shaped construction element

According to a preferred embodiment, the construction elements of the basin are placed on a concrete slab and are connected to the concrete slab by a connection suitable for absorbing a vertical force. This prevents lifting of the empty basin as a result of the upward pressure in a moisture-rich ground.

A further preferred embodiment provides the measure that the area over which the concrete slab extends is greater than the area of the basin. This further reduces the chance of lifting.

Basins with an overflow edge require the overflow edge to be sealed up to its upper edge. In order to make this possible with minimal effort, the sealing means are formed by a continuous groove which is arranged in the end surface of the U-shaped elements and into which a sealing profile at least partially extends.

Seals usually form a problem in basins assembled from elements. In order to avoid these problems a preferred embodiment provides the measure that the U-shaped construction elements are provided with linear sealing means which extend along the end wall of both wall parts, and along the bottom and the side walls of the gutter-like structures. Such seals are usually embodied in the form of grooves which extend in the separating surfaces of the wall and in which elongate profiles are placed. These seals can herein be placed in one of the two separating surfaces of walls to be sealed, although it is likewise possible, subject to the nature of the profile, for such a groove with profile to be placed in only one of the separating surfaces. It is also possible for two grooves, each with a profile, to extend in a separating surface of a wall, this providing the option of using a continuous profile, although it is also possible to make use of a single groove with a single profile.

In order to enable transport of the elements on the public highway without special provisions, a preferred embodiment provides the measure that the U-shaped element has a maximum width of 2.5 m.

The U-shaped elements are fixed against relative displacement on the separating surfaces by fixation pins and fixation holes or by grooves and protrusions which are integrated into the elements and which mutually engage during assembly. A preferred embodiment thus provides structures fixing, by form-locking, the relative position in the directions of the separating surface of the mutually adjacent elements.

The present invention will be elucidated hereinbelow on the basis of the accompanying figures, in which:

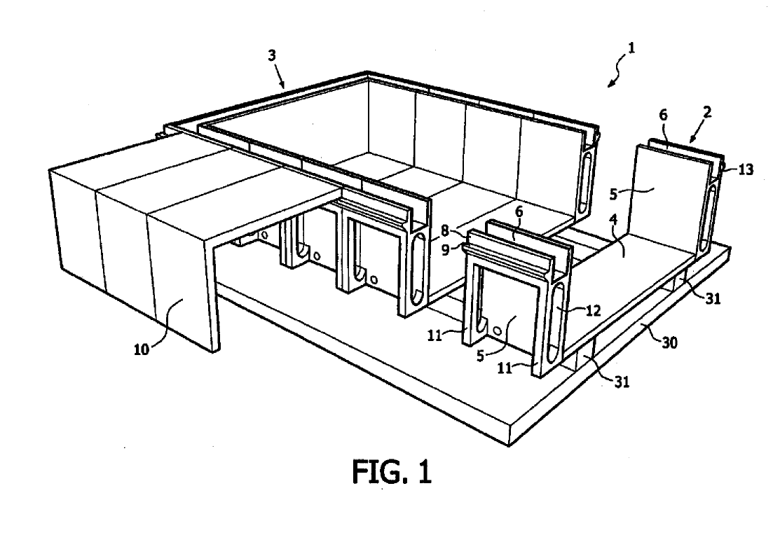

FIG. 1 shows a perspective schematic, partially broken-away view of a swimming pool basin according to the invention;

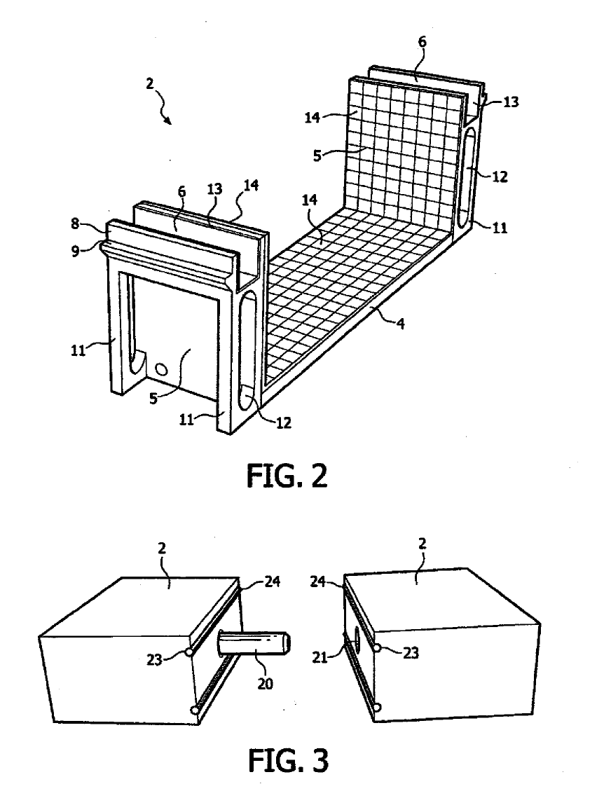

FIG. 2 shows a perspective schematic, partially broken-away view of a U-shaped element according to the invention;

FIG. 3 is a perspective detail view of two U-shaped elements according to the invention;

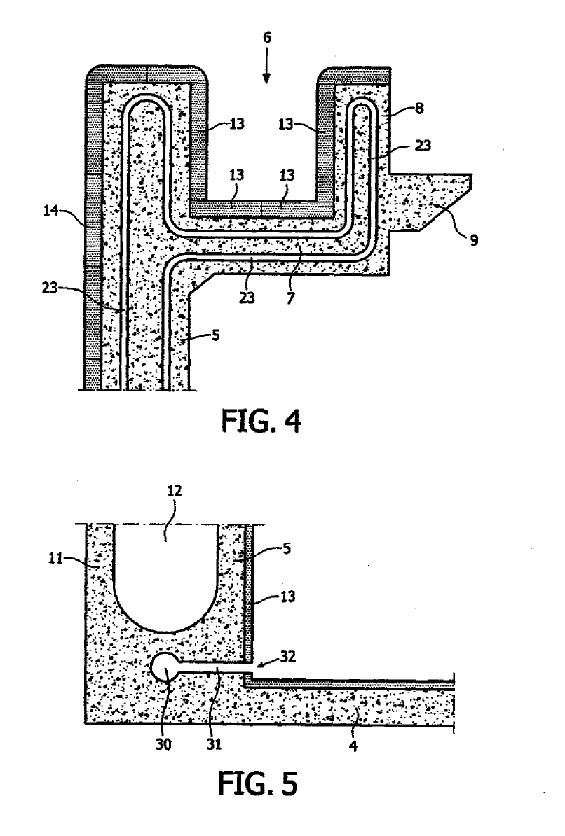

FIG. 4 is a side view of a U-shaped element according to the invention; and FIG. 5 is a cross-sectional view of a detail of an embodiment.

FIG. 1 shows a swimming pool basin 1 assembled born U-shaped construction elements 2 and end wall elements 3. The U-shaped construction elements 2 each comprise a bottom element 4 and two side walls S which preferably take a monolithic form in concrete. The U-shaped construction elements are each provided on their outer side with an overflow gutter 6 which preferably also forms a monolithic whole with the other parts of U-shaped construction element 2. Overflow gutter 6 comprises a bottom 7 and an outer side wall 8. Formed against outer wall 8 is a support nose 19 which serves to support terrace elements 10, which in the present example are L-shaped, so that space is created under the terrace elements for access to side walls 4 of U-shaped construction elements 2 of swimming pool basin 1. Overflow gutter 6 can be provided with an inner covering 13. It is noted here that U-shaped element 2 can be assembled from parts such as a bottom part and two side wall parts.

For the purpose of supporting overflow gutter 6 support elements 11, which are also formed integrally with the associated U-shaped element 2, are arranged connecting to the end walls. These support elements 11 impart more stability to overflow gutters 6 but also preferably serve to facilitate establishing a mutual connection between U-shaped construction elements 2, for instance with a screw connection. Support elements 11 do after all comprise readily accessible surfaces in which such screw connections can be arranged. Openings 12 through which conduits can extend are also arranged in support elements 11.

The swimming pool basin is herein placed on an already pre-cast concrete base slab 30.

The U-shaped elements 2 rest on base slab 30 by means of beams 31. U-shaped elements 2 are preferably connected by means of continuous connections to base slab 30 so that a possible upward pressure on the empty swimming pool basin 1 is transmitted to base slab 30, and this upward force is counteracted.

As shown in FIG. 2, side walls S and bottom 4 of U-shaped elements 2 are provided with a covering, for instance with a tile layer 14. It will be apparent that other types of covering can be applied instead of this tile layer, such as natural stone, plastics or metal sheets.

The U-shaped construction elements are all manufactured in a factory and subsequently transported to the construction site. It is therefore important that their width does not exceed 2.5 m in order to enable transport by road and by sea container without special provisions. Because these elements must usually be displaced using a crane, it is however also important that they are not too heavy. The measures according to the invention do however require that the elements have a length corresponding to the width of the swimming pool basin to be constructed, and this may entail the length, and thereby the mass, of such a U-shaped element being considerable. In respect of the maximum permissible length of road vehicles the maximum length is here 15 m. In order to nevertheless allow handling of these elements by a crane which is not too large, it is important that the width is not too great. By selecting a width not greater than 1.2 m it is found that the elements can at least be handled by a truck-mounted crane, while two elements can be placed next to each other on a truck and two elements can be placed next to each other in a sea container.

The U-shaped elements 2 must be fixed and sealed relative to each other. For the lateral fixation use is preferably made of dowels 20 which are arranged in the end surfaces of U-shaped construction elements 2 as shown in the detail FIG. 3. This shows that the U-shaped construction elements are provided on one side with dowels 20 which fit into openings 21 arranged in the other end surface. For fixation in the lengthwise direction use is preferably made of the screw connections already described with reference to the support elements.

The sealing between U-shaped construction elements takes place by making use of grooves 23 which are arranged in the end surfaces of the construction elements and which arc likewise shown in FIG. 3, and in which is arranged a sealing profile preferably manufactured from rubber or plastic. As shown in FIG. 3, the U-shaped construction elements are provided with two parallel extending grooves 23 with profiles 24 arranged therein. It will be apparent that it is also possible to suffice with a single groove including profile 24.

Finally, FIG. 4 shows a detailed cross-section of such an element, wherein that part of a U-shaped construction element is shown which comprises an overflow gutter. This shows that groove 23 with profile 24 arranged therein extends up to the upper edge of the wall between the actual basin and the overflow gutter. This is important because the height of this wall, and hereby also the height of the seal between the elements constituting this wall, defines the height of the water level in the basin. The groove together with the profile arranged therein is also shown to extend in dual form. The sealing is hereby improved and arranging is moreover facilitated because use can be made of a single sealing profile.

That which is stated above in respect of the mutual connection between the U-shaped elements 2 likewise applies in respect of the connection between an end wall and the U-shaped element 2 connecting thereto.

FIG. 5 shows a cross-sectional view of an embodiment of a U-shaped construction element 2 according to the invention, wherein a conduit 30 for feeding water to basin 2 is received in U-shaped construction element 2. In the shown example conduit 30 is cast into element 2, i.e. conduit 30 is also made from concrete and is formed during casting of the concrete. The use of high-strength concrete makes this construction possible. It is however also possible to cast such a conduit 30 when use is made of a separate conduit, manufactured for instance from another material. When a U-shaped element is used which is assembled from three separate elements, there is the further possibility of the conduits being enclosed between the elements. This figure also shows that a short transverse conduit 31 extends from conduit 30 to basin 1 and debouches in the basin by means of an opening 32.

1. Method for constructing a concrete basin, comprising the following steps of:
manufacturing concrete construction elements;
transporting the construction elements to the construction site for the basin;
joining the construction elements together to form a basin; and
arranging covering on the inner side of the walls and bottom of the basin, characterized in that the inner covering is arranged before the construction elements are transported to the construction site for the basin.

2. Method as claimed in claim 1, characterized in that the basin is assembled from at least one U-shaped construction element and end construction elements.

3. Method as claimed in claim 2, characterized in that the U-shaped construction elements are assembled at the construction site from elements extending in one plane.

4. Method as claimed in claim 1, 2 or 3, characterized in that after placing of a construction element connecting to a construction element that is already present, the placed construction element is connected to the already present construction element before a subsequent construction element is placed.

5. Method as claimed in claim 4, characterized in that the construction elements are mutually connected by self-locking dowels.

6. Method as claimed in any of the foregoing claims, characterized in that the method results in a swimming pool basin.

7. Basin, comprising:
at least one U-shaped construction element which is manufactured substantially from concrete and which comprises a floor part and two side wall parts; and
at least two end construction elements manufactured substantially from concrete, wherein the side wall parts of the U-shaped construction elements are placed with their end surface against each other and wherein the end construction elements are placed with their end surface against the end surface of the outermost U-shaped elements, characterized in that the construction elements are mutually separated by sealing elements, and that a gutter-like element forming a monolithic whole with the U-shaped construction element is arranged connecting to the upper edge of both side wall parts of the U-shaped construction elements.

8. Basin as claimed in claim 7, characterized in that the U-shaped construction elements are assembled from elements extending in one plane.

9. Basin as claimed in claim 7 or 8, characterized in that the basin is a swimming pool basin.

10. Basin as claimed in claim 7, 8 or 9, characterized in that the gutter-like structures are arranged on the outer side of the side wall parts of the U-shaped construction elements.

11. Basin as claimed in claim 7, 8, 9 or 10, characterized in that the U-shaped construction elements are provided with support noses arranged against the outer wall of the gutter-like structures and forming a monolithic whole with the associated U-shaped construction element.

12. Basin as claimed in claim 11, characterized in that openings for passage of at least one pipe or conduit are arranged in the supports.

13. Basin as claimed in claim 11, characterized in that the element is provided with at least one conduit formed integrally with the associated element.

14. Basin as claimed in claim 8, characterized in that the element is provided with at least one conduit arranged in a cavity bounded by two substantially flat parts.

15. Basin as claimed in any of the claims 7-14, characterized in that the basin is provided with an inner covering and that separating lines in the inner covering of the basin coincide with separating surfaces between adjacent U-shaped construction elements.

16. Basin as claimed in any of the claims 7-15, characterized in that the basin is manufactured from high-strength concrete.

17. Basin as claimed in any of the claims 7-16, characterized in that the U-shaped construction elements are reinforced by plastic or metal fibres.

18. Basin as claimed in any of the claims 7-17, characterized in that end construction elements extending substantially vertically and manufactured substantially from concrete are arranged on the outer side of the U-shaped construction elements, and that the end construction elements are both provided with a concrete gutter-like structure which forms a monolithic whole with the end construction element and which connects to the gutter-like structure of the adjacent U-shaped construction element.

19. Basin as claimed in any of the claims 7-18, characterized in that the sealing means comprise a continuous groove which is arranged in at least the end surface of the U-shaped construction elements and in which a sealing profile at least partially extends.

20. Basin as claimed in any of the claims 7-18, characterized in that the construction elements of the swimming pool basin are placed on a concrete slab and are connected to the concrete slab by a connection suitable for absorbing a vertical force.

21. Basin as claimed in claim 20, characterized in that the area over which the concrete slab extends is greater than the area of the basin.

22. U-shaped construction element as component for a basin, comprising a floor part and two side wall parts, wherein the U-shaped construction element is manufactured from concrete, characterized in that a gutter-like element is arranged connecting to the upper edge of both side wall parts of the U-shaped construction element and forming a monolithic whole with at least the associated side wall part of the construction element.

23. U-shaped construction element as claimed in claim 22, characterized in that the U-shaped construction element is provided on its inner side with a covering.

24. U-shaped construction element as claimed in claim 22 or 23, characterized in that the U-shaped construction element is manufactured from high-strength concrete.

25. U-shaped construction element as claimed in claim 22, 23 or 24, characterized in that the U-shaped construction element is provided with linear sealing means which extend along the end wall of both wall parts, and along the bottom and the side walls of the gutter-like structures.

26. U-shaped construction element as claimed in claim 25, characterized in that the U-shaped construction element is provided on only one of its sides with sealing means.

27. U-shaped construction element as claimed in claim 22, 23, 24 or 25, characterized in that the U-shaped construction element has a maximum width of 2.5 m.

28. U-shaped construction element as claimed in claim 26, characterized in that the U-shaped construction element is provided on its side surfaces with structures fixing, by form-locking, the relative position in the directions of the separating surface of the mutually adjacent elements.
